(19) United States
(12) Patent Application Publication
(10) Pub. No.: US 2010/0180096 A1
(43) Pub. Date: Jul. 15, 2010

(54) LICENSE DATA FOR CONTROLLING PARTIAL AVOIDANCE OR SIMULTANEOUS ACCESS TO MULTIMEDIA CONTENTS, AND APPARATUS AND METHOD FOR CONSUMING MULTIMEDIA CONTENTS USING THIS LICENSE DATA

(76) Inventors: Hyon-Gon Choo, Daejon (KR); Young-Bae Byun, Seoul (KR); Gun Bang, Daejon (KR); Bum-Suk Choi, Daejon (KR); Je-Ho Nam, Daejon (KR); Jin-Woo Hong, Daejon (KR)

Correspondence Address: LADAS & PARRY LLP, 224 SOUTH MICHIGAN AVENUE, SUITE 1600, CHICAGO, IL, 60604, US

(21) Appl. No.: 12/294,990

(22) PCT Filed: Mar. 30, 2007
(86) PCT No.: PCT/KR2007/001561

§ 371 Date: Oct. 24, 2008

(30) Foreign Application Priority Data
Mar. 30, 2006 (KR) 10-2006-0028846

(51) Int. Cl. G06F 12/14; G06F 12/00; G06F 21/24

(52) U.S. Cl. 711/168; 726/28; 711/E12.094; 711/E12.001

(57) ABSTRACT

Provided is a technology for controlling partial avoidance or simultaneous access to multimedia contents. This research provides a multimedia contents consuming apparatus, which includes: a receiver for receiving a multimedia content and license data representing a condition for prohibiting partial avoidance of the multimedia content; a license analyzer for receiving the license data from the receiver, analyzes the license condition for the multimedia content, and creating a control signal for partial avoidance; and a controller for controlling avoidance for a predetermined part of the multimedia content according to the control signal.

### TECHNICAL FIELD

The present invention relates to license data for controlling partial avoidance or simultaneous access to multimedia contents, and an apparatus and method for consuming the multimedia contents using the license data.

### BACKGROUND ART

Multimedia data in a broadcasting and streaming environment are transmitted through a satellite network, terrestrial network, a cable network, and the Internet. Users may play or copy the transmitted resources in their device. Stored resources may be modified, or exported or copied to other devices. In the present specification, the use of multimedia contents in diverse forms is referred to as ‘consumption.’

Meanwhile, avoiding or accessing to multimedia contents needs to be restricted in the above environments. In the first place, when a multimedia content includes an advertisement therein, an earning rate may differ according to a probability of avoiding the ad. Thus, it is necessary to prevent a user from skipping the ad part. Secondly, the range of simultaneous access to resources that are currently on air needs to be restricted.

However, conventional contents consuming apparatuses have a problem in that a user may skip the ad part through partial avoidance, when a multimedia content is played or stored. Also, the conventional contents consuming apparatuses does not have a means for controlling the number of contents consuming apparatuses permitted for simultaneous access to multimedia contents.

### DISCLOSURE

### Technical Problem

An embodiment of the present invention is directed to provide license data representing a condition for avoiding or accessing to multimedia contents.

Another embodiment of the present invention is directed to provide a multimedia contents consuming apparatus for controlling partial avoidance of a multimedia content.

Another embodiment of the present invention is directed to provide a multimedia contents consuming apparatus for controlling simultaneous access to multimedia contents.

### Technical Solution

In accordance with an aspect of the present invention, there is provided an apparatus for consuming multimedia contents, which includes: a receiver for receiving a multimedia content and license data representing a condition for prohibiting partial avoidance of the multimedia content; a license analyzer for receiving the license data from the receiver, analyzing the license condition for the multimedia content, and creating a control signal for partial avoidance; and a controller for controlling avoidance for a predetermined part of the multimedia content according to the control signal.

The partial avoidance prohibition condition may be information on an interval of the multimedia content in which the partial avoidance is prohibited. The time information may include a start time and a duration.

In accordance with another aspect of the present invention, there is provided an apparatus for consuming multimedia contents, which includes: a receiver for receiving a multimedia content and license data representing a condition for permitting simultaneous access for the multimedia content; a license analyzer for receiving the license data from the receiver, analyzing the license condition for the multimedia content, and creating a control signal for simultaneous access; and a controller for controlling simultaneous access to the multimedia content according to the control signal.

The simultaneous access permission condition may include a number, which is the number of multimedia contents consuming apparatuses available for simultaneous access, or as a period to which the simultaneous access permission number is applied.

In accordance with another aspect of the present invention, there is provided a method for consuming multimedia contents, which includes the steps of: a) receiving a multimedia content and license data representing a condition for prohibiting partial avoidance of the multimedia content; b) extracting the license condition for the multimedia content from the license data, and creating a control signal for partial avoidance; and c) controlling avoidance for a predetermined part of the multimedia content according to the control signal.

In accordance with another aspect of the present invention, there is provided a method for consuming multimedia contents, which includes the steps of: a) receiving a multimedia content and license data representing a condition for permitting simultaneous access to the multimedia content; b) extracting the license condition for the multimedia content from the license data, and creating a control signal for simultaneous access; and c) controlling simultaneous access to the multimedia content according to the control signal.

In accordance with another aspect of the present invention, there is provided license data for controlling partial avoidance of a multimedia content, which include data representing a partial avoidance prohibition condition for the multimedia content.

In accordance with another aspect of the present invention, there is provided license data for controlling simultaneous access to a multimedia content, which include: data representing the number of multimedia contents consuming apparatuses available for simultaneous access to the multimedia content; and data representing a period to which the simultaneous access permission number is applied.

### ADVANTAGEOUS EFFECTS

As described above, the apparatus and method of the present invention can represent a condition for partial avoidance (i.e., skipping) of and simultaneous access to a multimedia content by using license data, and control the skipping and simultaneous access to multimedia contents based on the license data. Preventing a user from skipping an ad inserted in a multimedia content can secure added values made from the ad.

### BRIEF DESCRIPTION OF THE DRAWINGS

FIG. 1 is a block view showing a multimedia contents consuming apparatus in accordance with an embodiment of the present invention.

FIG. 2 is a flowchart describing a multimedia contents consuming method in accordance with an embodiment of the present invention.

FIG. 3 shows language representation describing how to control partial avoidance in multimedia contents in accordance with an embodiment of the present invention.

FIG. 4 shows language representation describing how to control simultaneous access to multimedia contents in accordance with an embodiment of the present invention.

### BEST MODE FOR THE INVENTION

The advantages, features and aspects of the invention will become apparent from the following description of the embodiments with reference to the accompanying drawings, which is set forth hereinafter. The same reference numeral is given to the same or similar constituent element, although it appears in different drawings.

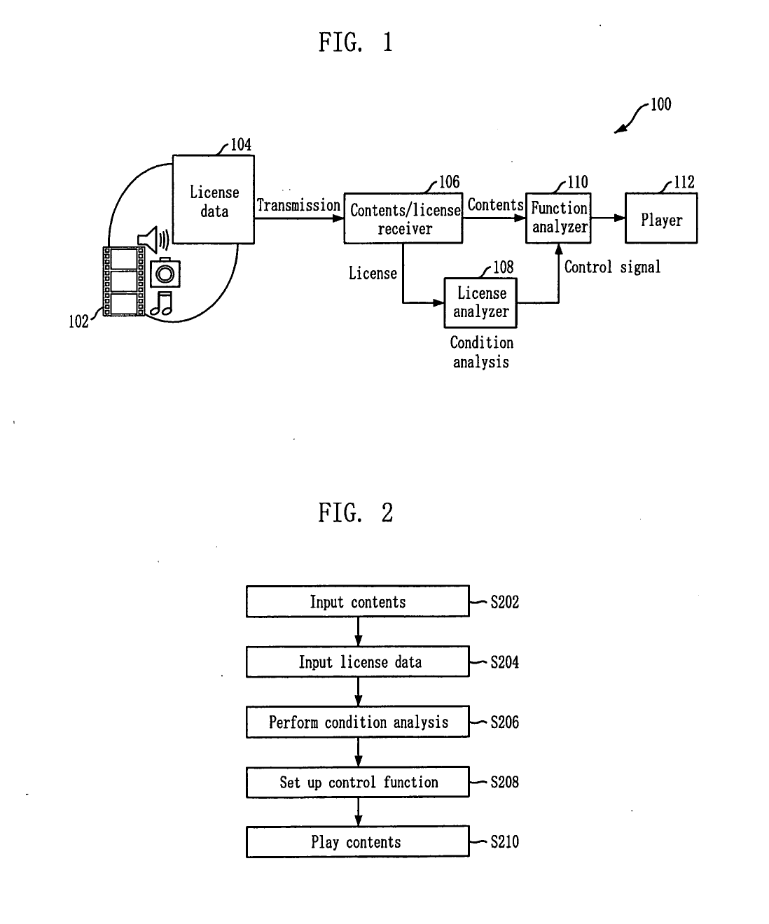

FIG. 1 is a block view showing a multimedia contents consuming apparatus in accordance with an embodiment of the present invention. Referring to the drawing, the multimedia contents consuming apparatus 100 includes a contents/license receiver 106, a license analyzer 108, a function controller 110, and a player 112.

The contents/license receiver 106 receives a multimedia content 102 and license data 104 on the multimedia content. Herein, the license data 104 represents the starting time and a duration of a part in which partial avoidance is prohibited, and represents the number and period of available simultaneous access. The license data 104 may be included in the multimedia content and then transmitted, or the license data 104 may be transmitted to the contents/license receiver 106 through a separate channel. The contents/license receiver 106 separates the license data 104 from the received data and transmits the license data 104 to the license analyzer 108.

The license analyzer 108 receives the license data 104 from the contents/license receiver 106, analyzes a license condition on the multimedia content 102 out of the license data 104, and creates a control signal for controlling partial avoidance and simultaneous access. The control signal is provided to the function controller 110.

The function controller 110 controls partial avoidance of and simultaneous access to the multimedia content by setting up a buffer, a skip function, and a simultaneous access function according to the control signal transmitted from the license analyzer 108.

The player 112 plays the multimedia contents 102 under the control of the function controller 110. The present embodiment shows an example of a multimedia contents playing apparatus. In a case of a storing apparatus, however, a memory unit is set up instead of the player 112.

FIG. 2 is a flowchart describing a multimedia contents consuming method in accordance with an embodiment of the present invention. In steps S202 and S204, a multimedia content 102 and license data 104 on the multimedia content 102 are inputted through a wired/wireless communication network. The license data 104 represents the starting time and duration of a part in which partial avoidance is prohibited and also represents the number and period of available simultaneous access. Subsequently, in step S206, a license condition on the multimedia content 102 is analyzed out of the license data 104, and a control signal for controlling partial avoidance and simultaneous access is created. In step S208, a control function for controlling the partial avoidance of and simultaneous access to the multimedia contents 102 is set up according to the control signal. In step S210, the multimedia content 102 is played.

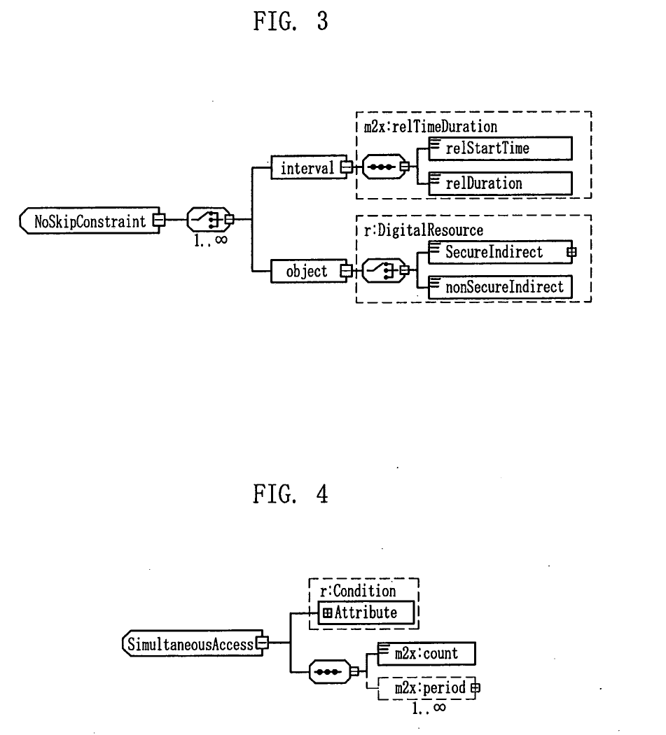

FIG. 3 shows language representation describing how to control partial avoidance in multimedia contents in accordance with an embodiment of the present invention. A condition may define a constraint condition for partial avoidance in one resource. Referring to FIG. 3, ‘relStartTime’ denotes the starting time of a part of the multimedia content in which partial avoidance is prohibited, and ‘relDuration’ denotes time that the partial avoidance-prohibited part lasts.

When this condition is included in a license authentication, partial avoidance (i.e., skipping) can be prohibited for a given condition when a multimedia content is played or stored. For example, a user cannot skip a predetermined multimedia content in the forward or backward for the constraint time at a predetermined starting time. Broadcasting businesses make a profit on inserting ads in predetermined multimedia contents. They prevent a user from skipping the ads by using a given condition and acquire added values from the ads.

The following Table 1 shows an exemplary syntax of Rights Expression Language (REL) when partial avoidance starts at 30 minutes and the partial avoidance duration time is 15 minutes.

TABLE 1
<r:grant>

<m1x:IdentityHolder licensePartid=“deviceID”>

<m1x:idSystem>um:mpeg:mpeg21:2006-01-REL-M2X-NS:DM-01000</m1x:idSystem>
<m1x:idValue>DE1234567</m1x:idValue>

</m1x:IdentityHolder>
<m1x:govenedCopy/>
<r:digitalResource>

<r:nonSecureIndirect URI=“urn:broadcast:news:2005_07_10-12H-00M”/>

</r:digitalResource>
<m2x:noskipConstraint>

<m2x:internal>

<m2x:relStartTime>PT30M</m2x:relStartTime>
<m2x:relDuration>PT15M</m2x:relDuration>

</m2x:interval>

</m2x:noskipConstraint>

</r:grant>

An exemplary syntax of eXtensible Markup Language (XML) for the above function is as shown in Table 2.

TABLE 2

<xsd:complexType name=“NoSkipConstraint”>

<xsd:complexContent>

<xsd:extension base=“r:Condition”>

<xsd:choice maxOccurs=“unbounded”
minOccurs=“0”>

<xsd:element name=“interval”
type=“m2x:RelTimeDuration”/>
<xsd:element name=“object”
type=“r:DigitalResource”/>

</xsd:choice>

</xsd:extension>

</xsd:complexContent>

</xsd:complexType>

FIG. 4 shows language representation describing how to control simultaneous access to multimedia contents in accordance with an embodiment of the present invention. This condition can control the number and time of simultaneous access to one resource. When the condition is included in the license, apparatuses as many as a number defined in the ‘counter’ can accesses to the resources for a time period defined in the ‘period.’

The following Table 3 shows an example of an REL syntax when 3 to 5 apparatuses are allowed to play the resources for a period from July 2006 to December 2006.

TABLE 3

<r:grant>

<mx:play/>
<r:digitalResource>

<r:nonSecureIndirect
URI=“um:broadcast:news:2005_07_10-12H-00M”/>

</r:digitalResource>
<m2x:simultaneousAccess>

<m2x:count>5</m2x:count>
<m2x:period>

<notBefore>2006-7-01:T00:00:00</notBefore>
<notAfter>2006-12-31T00:00:00</notAfter>

</m2x:period>

</m2x:simultaneousAccess>

</r:grant>

An example of an XML syntax for the above function is shown in the following Table 4.

TABLE 4
<xsd:element name=“simultaneousAccess”
type=“m2x:SimultaneousAccess”
substitutionGroup=“r:condition”/>
<xsd:complexType name=“SimultaneousAccess”>
<xsd:complexContent>

<xsd:extention base=“r:Condition”>
<xsd:sequence>

<xsd:element name=“count” type=“xsd:positiveinteger”/>
<xsd:element name=“period” type=“r:ValidityInterval”
minOccurs=“0”

maxOccurs=“unbounded”/>

</xsd:sequence>
</xsd:extention>

</xsd:complexContent>
</xsd:complexType>

### MODE FOR INVENTION

The above described embodiments are presented to help those skilled in the art easily understand the present invention, and they do not limit the scope of the present invention.

While the present invention has been described with respect to certain preferred embodiments, it will be apparent to those skilled in the art that various changes and modifications may be made without departing from the scope of the invention as defined in the following claims.

### INDUSTRIAL APPLICABILITY

As described above, the present invention can represent a condition for skipping and simultaneous access to multimedia contents through license data. The license data makes it possible for a multimedia contents consuming apparatus to control the skipping and simultaneous access to the multimedia contents based on the license data. The present invention secures additional values by preventing a user from skipping an ad inserted into a multimedia content.

1. An apparatus for consuming multimedia contents, comprising:
a receiver for receiving partial avoidance prohibition condition information representing a condition for prohibiting partial avoidance of the multimedia content; and
a controller for analyzing the partial avoidance prohibiting condition information and controlling the partial, avoidance for a predetermined part of the multimedia content.

2. The apparatus of claim 1, wherein the partial avoidance prohibition condition includes interval information of the multimedia content in which the partial avoidance is prohibited.

3. The apparatus of claim 2, wherein the interval information is time information including a start time and a duration or a start time and an end time.

4. (canceled)

5. (canceled)

6. An apparatus for consuming multimedia contents, comprising:
a receiver simultaneous access permission condition information representing a condition for permitting simultaneous access for the multimedia content; and
a controller for analyzing the simultaneous access permission condition information and controlling permission of the simultaneous access to the multimedia content.

7. The apparatus of claim 6, wherein the simultaneous access permission condition includes a number, which is the number of multimedia contents consuming apparatuses available for the simultaneous access.

8. The apparatus of claim 7, wherein the simultaneous access permission condition further includes a period to which the simultaneous access permission number is applied.

9. (canceled)

10. A method for consuming multimedia contents, comprising the steps of:
receiving partial avoidance prohibition condition information representing a condition for prohibiting partial avoidance of the multimedia content; and
analyzing the partial avoidance prohibiting condition information and controlling the partial avoidance for a predetermined part of the multimedia content.

11. The method of claim 10, wherein the partial avoidance prohibition condition includes interval information of the multimedia content in which the partial avoidance is prohibited.

12. The method of claim 11, wherein the interval information is time information including a start time and a duration or a start time and an end time.

13. (canceled)

14. (canceled)

15. A method for consuming multimedia contents, comprising the steps of:
receiving simultaneous access permission condition information representing a condition for permitting simultaneous access for the multimedia content; and
analyzing the simultaneous access permission condition information and controlling Permission of the simultaneous access to the multimedia content.

16. The apparatus of claim 15, wherein the simultaneous access permission condition includes a number, which is the number of multimedia contents consuming apparatuses available for the simultaneous access.

17. The apparatus of claim 16, wherein the simultaneous access permission condition further includes a period to which the simultaneous access permission number is applied.

18. License data for controlling partial avoidance of a multimedia content, comprising:
data representing a partial avoidance prohibition condition for the multimedia content, wherein the partial avoidance prohibition condition includes information on an interval of the multimedia content in which the partial avoidance is prohibited.

19. (canceled)

20. The license data of claim 18, wherein the content interval information is time information including a start time and a duration or a start time and an end time.

21. (canceled)

22. (canceled)

23. License data for controlling simultaneous access to a multimedia content, comprising:
data representing the number of multimedia contents consuming apparatuses available for simultaneous access to the multimedia content; and
data representing a period to which the simultaneous access permission number is applied.
